(19) United States
(12) Patent Application Publication
(10) Pub. No.: US 2001/0004033 A1
(43) Pub. Date: Jun. 21, 2001

(54) Elevator

(76) Inventors: Hideki Nihei, Hitachiota-shi (JP); Hiroshi Nagase, Hitachi-shi (JP); Hiromi Inaba, Hitachinaka-shi (JP); Toshiyuki Tadokoro, Funabashi-shi (JP)

Correspondence Address: Antonelli, Terry, Stout & Kraus, LLP, Suite 1800, 1300 North Seventeenth Street, Arlington, VA, 22209, US

(21) Appl. No.: 09/733,094

(22) Filed: Dec. 11, 2000

(30) Foreign Application Priority Data
Dec. 9, 1999 (JP) 11-349786

(51) Int. Cl. B66B 1/00

(52) U.S. Cl. 187/289; 187/276

(57) ABSTRACT

An elevator in which an elevator-car and a counter weight are hung like a draw well. The elevator includes a receiving unit for receiving an electric power from a feeding unit provided in a hoistway, an inverter for converting the received electric power into ac power, a motor connected to an ac side of the inverter, for driving the counter weight in up and down directions, a sensor for detecting a position of a receiving unit, and a control unit for controlling an inverter on the basis of the position detected by the position sensor. The counter weight has the receiving means, the inverter, and the motor.

### BACKGROUND OF THE INVENTION

The present invention relates to an elevator, and particularly to an elevator in which a receiving unit is installed in a counter weight.

There is the Japanese Patent Application Laid-Open No. 57-121568 as a prior art, in which a drive unit is installed in a counter weight of an elevator. A primary side of a linear motor and an inverter, and a battery charger are installed in the counter weight in this prior art. This battery charger is connected to a main electric power source system across a sonnet connector when the counter weight stops at the bottom position, and the electric power is supplied to the battery charger.

Further, the Japanese Patent Application Laid-Open No. 5-294568 describes that when the elevator-car arrives at the stop floor, the electric power is supplied to the elevator-car in a non-contact way.

It is required to stop the counter weight at a feeding position with accuracy in order to feed the electric power to the counter weight. Generally, the elevator-car is designed so as to stop accurately at each of the stop floors. However, to stop accurately the counter weight at a predetermined position is out of consideration. As a result, there is a fear that the counter weight can not stop at the feeding power position because of the rope expansion, and it becomes impossible to supply the electric power to the counter weight.

There is no consideration that it becomes impossible to supply the electric power to counter weight because of such rope expansion in the Japanese Patent Application Laid-Open No. 57-121568.

In a word, mechanical parts are connected when feeding power, and the separation is repeated.

In the prior art described in the Japanese Patent Application Laid-Open No. 5-294568, it is not required to stop the counter weight with a high degree of accuracy because the electric power is fed to the elevator-car side. In a word, it is not considered to stop the counter weight in high accuracy in consideration of the rope expansion caused by the use of the elevator.

### SUMMARY OF THE INVENTION

An object of the present invention is to provide an elevator in which the electric power can be surely supplied to the counter weight.

In order to attain the above-mentioned object, the elevator of the present invention includes a receiving means for receiving an electric power from a feeding means provided in a hoistway, an inverter for converting the received electric power into ac power, a motor connected to an ac side of the inverter, for driving said counter weight in up and down directions, a means for detecting a position of a receiving means; and a means for controlling the inverter on the basis of the position detected by the position detecting means. The counter weight has the receiving means, the inverter, and the motor.

### BRIEF DESCRIPTION OF THE DRAWINGS

FIG. 1 is a perspective view of an elevator according to an embodiment of the present invention.

FIG. 2 is a block diagram showing the configuration of an electric system according to the embodiment of the present invention.

FIG. 3 is a schematic view showing the outline in section of a feeding unit 131 and a receiving unit 113.

FIG. 4 is a flow chart illustrating operation and feeding power of elevator according to the embodiment.

FIG. 5A is a schematic view showing the section of a feeding system 131 and a receiving unit 113 according to another embodiment of the invention.

FIG. 5B is a graph showing the characteristic of a transformer according to another embodiment.

FIG. 6 is a schematic view showing the section of a feeding system 131 and a receiving unit 113 according to another embodiment.

FIG. 7 is a top view of an elevator according to another embodiment.

FIG. 8 is a front elevation of the elevator shown in FIG. 7.

FIG. 9 is a schematic view showing the section of a feeding system 131 and a receiving unit 113 according to a further embodiment.

### DETAILED DESCRIPTION OF THE PREFERRED EMBODIMENTS

An embodiment of the present invention will be explained hereinafter with reference to the drawing.

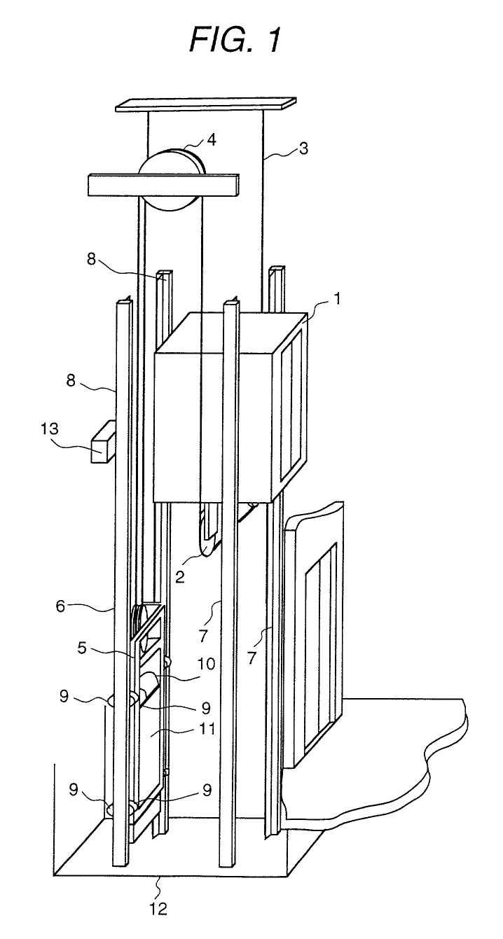

FIG. 1 is a perspective view of an elevator according to an embodiment of the present invention.

An elevator-car 1 has a pulley 2 under the elevator-car. A rope 3 hangs in top pulley 4 via the lower side of pulley 2, one end of the rope 3 is fixed to the top of a hoistway. Further, the rope 3 suspends a pulley 6 installed in the upper part of counter weight 5. The other end of the rope 3 is also fixed to the top of the hoistway. In such a way, the elevator-car 1 and the counter weight 5 are hung like a draw well, and hung respectively by 2:1 roping.

The elevator-car 1 is constructed so as to be guided in a vertical direction freely with elevator-car rails 7 installed in up and down directions of the hoistway and the guide shoes or guide rollers (not shown) installed on the rail side of the elevator-car 1. In a similar way, the counter weight 5 is also guided in a vertical direction freely with the guide-rail 8 of the counter weight installed in up and down directions of the hoistway and roller 9 installed on the guide-rail side of the counter weight.

Further, a rotary motor 10 for driving the counter weight 5 in up and down directions, a control panel 11 which controls the motor 10, and a damping unit 12 are installed in the counter weight 5. One of the rollers 9 is connected to the motor 10. In addition, a feed system 13 for supplying the electric power to the control panel 11 of counter weight 5 is installed in the hoistway. This feed system 13 is installed at the position opposed to the position of counter weight 5 when the elevator-car has stopped in a standard floor (In this embodiment, the lowest floor). Therefore, when the elevator-car 1 stops in the standard floor, an electric power is fed to the control panel 11.

Further, one of the rollers 9 which come in contact with the guide-rails 8 is connected to the motor 10. The counterweight 5 is moved up and down by the rotation of the roller 10. An elevator-car 1 moves up and down along with the movement of the counter weight 5. Further, when elevator-car 1 stops in the stop floor, a damping unit 12 clamps guide-rail 8, and thus stops the counter weight 5.

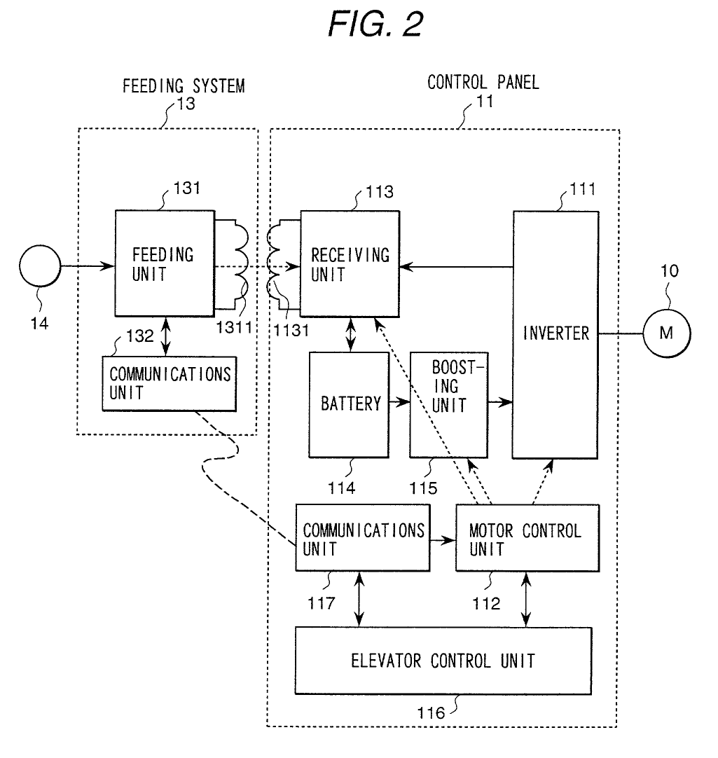

FIG. 2 is a block diagram showing the configuration of an electric system according to the embodiment of the present invention.

The feed system 13 is connected to building power supply 14, and the control panel 11 is connected to the motor 10.

The control panel 11 comprises an inverter 111 for supplying three-phase ac power to the motor 10 to drive it, a motor control unit 112 for controlling the inverter, a battery 114 for saving an electric power for drive, receiving unit 113 for charging a regenerative electric power from the inverter 111 and an electric power from the receiving system 11 to the battery 114, a boosting unit 115 for boosting an output power of the battery 14 to a voltage for motor drive, elevator control unit 116 for giving a motor drive command to the motor control unit 112, and a communication unit 117 for communicating with the feeding system 13.

The receiving unit 113 has transformer 1131. The feeding system 13 is composed of a feeding unit 131 for supplying the electric power received from the building power supply 14 to the receiving unit 113 through a transformer 1311 when it is necessary and possible to supply an electric power, and a communication unit 132 which communicates with the control panel 11.

In the above configuration, the electric power with battery 114 is usually obtained, motor 10 is driven, and it is possible to operate as an elevator. When a transformer 1311 on the feed side and a transformer 1131 on the reception side does not oppose with a high degree of accuracy, it is not possible to feed the electric power efficiently.

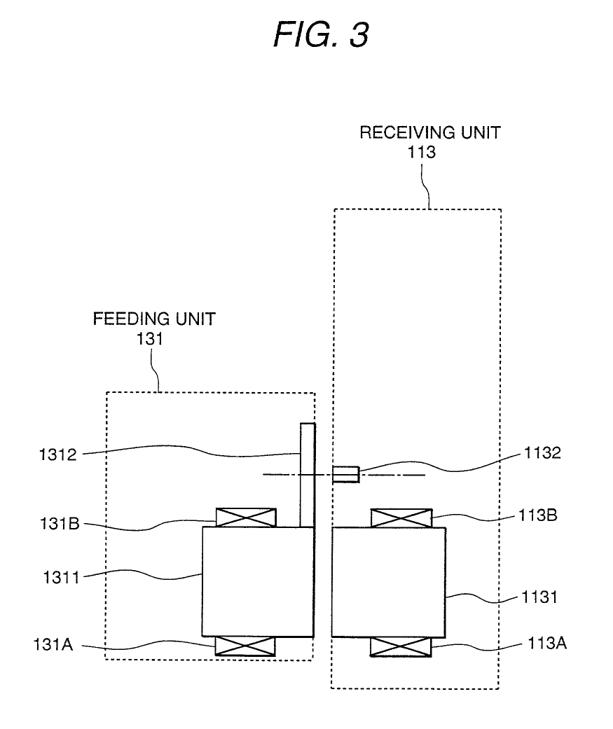

FIG. 3 is a schematic view showing the outline in section of a feeding unit 131 and a receiving unit 113.

A receiving transformer 1131 and a position sensing unit 1132 are built into the receiving unit 113, and a reference plate 1312 for sensing a position and a feeding transformer 1311 are built into the feeding system 131. The feeding transformer 1311 is composed of a coil 131A and a core 131B, and the receiving transformer 1131 is composed of a coil 113A and a core 113B.

Position sensing unit 1132 is set so as to be able to detect a reference position when the receiving transformer 1131 and the feeding power transformer 1311 oppose correctly to each other. As a result, the displacement from a reference position is detected, the motor 10 is driven, and thus the counter weight is controlled to correspond at the position where the receiving transformer 1131 and the feeding power transformer 1311 oppose correctly to each other.

As is known well, there are various kinds of position sensors such as the light type and the magnetic type. The explanation of the details is omitted here.

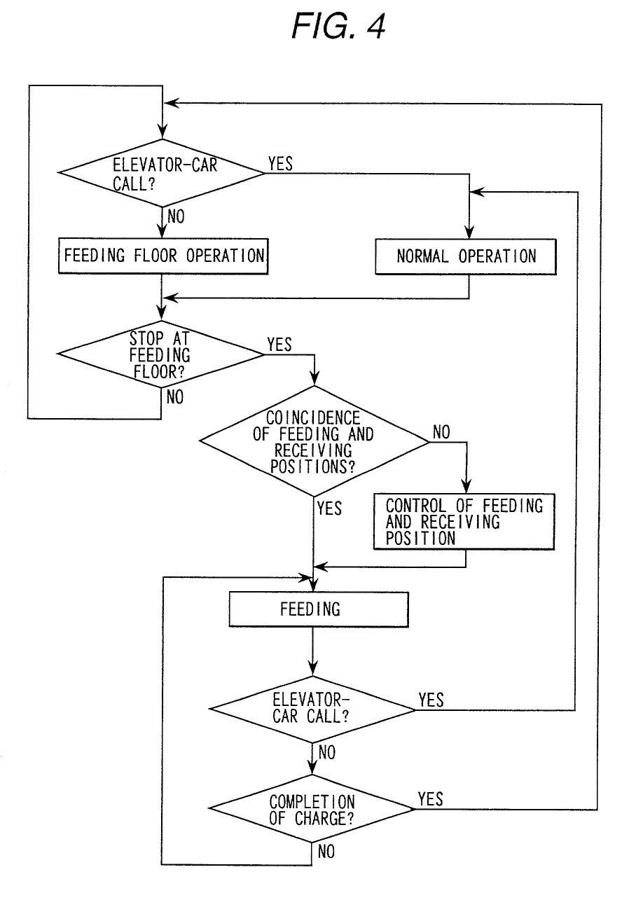

FIG. 4 is a flow chart illustrating operation and feeding power of elevator according to the embodiment.

It is judged whether or not there is elevator-car call. If the elevator-car call is occurred, then the elevator-car is driven in a normal operation. If there is no elevator-car call for a predetermined period of time and it is judged that now is in off-hour, then the elevator-car is driven in a feeding floor operation. The “feeding floor operation” means an operation for the movement to the feeding floor or the floor where the electric power can be supplied from the feeding unit to the receiving unit.

Elevator-car call information is transferred from the communications unit 132 of the feeding unit 13 to the elevator control unit 116 of the control panel 11 shown in FIG. 2 via a communications unit 117. Further, a command for moving the counter weight to the feeding floor is given from the elevator control unit 116 to the motor control unit 112. As a result, the inverter 111 drives the motor 10. When approaching the feeding floor, the position information is given from the communications unit 132 of the feeding unit 13 shown in FIG. 2 to the elevator control unit 116 via the communications unit 117, and the motor control unit 112 and the inverter 111 stops the motor 10.

When the elevator-car stops on the feeding floor, it is judged whether or not the positions of the feeding unit and the receiving unit is coincident with each other. If not coincident, the feeding and receiving position control is carried out to allow the positions to coincide. Namely, the feeding unit and the receiving unit are positioned by moving the counter weight. When positioning the feeding unit and the receiving unit, the position of the elevator-car may be displaced. It is determined that there is no passenger in the elevator-car because it have already been determined that there had been no elevator-car call for a predetermined period of time. However, in order to increase the safety, the feeding and receiving position control according to this embodiment is carried out when a sensing means for detecting passengers confirms that there is no passenger in the elevator-car. If the positions of the feeding unit and the receiving unit are coincident with each other, then the feeding operation is started. The operation of the above counter weight is performed by using the communications units 132 and 117, the elevator control unit 116, the motor control unit 112, the inverter 111 and the motor 10 in a way similar to that of the control system shown in FIG. 2. On feeding, the electric power is supplied from the feeding unit 131 to the receiving unit 113, and thus the battery is charged. The feeding operation is continued until the elevator-car call is occurred, or the battery on the receiving unit side is fully charged.

The normal operation and the feeding floor operation are performed without stagnation by the above-mentioned sequence, not ruining the function as an elevator.

Because the displacement between the stopping place of the elevator-car and the stopping place of the counter weight can be measured in this embodiment, the rope expansion can be presumed by using this result. Therefore, it is possible to inform the elevator manager and the maintenance trader of the presence of the necessity of the rope adjustment,

According to the above-mentioned embodiment, it is possible to control so that the receiving transformer may oppose correctly to the feeding power transformer by using the position sensor. Therefore, the counter weight is stopped at the feeding position with a high degree of accuracy even if there is a rope expansion, and it is possible to feed surely the electric power to the counter weight side.

In the above-mentioned embodiment, both the feeding unit and the receiving unit were positioned by the vertical motion of the counter weight. However, it may be possible to position them by moving vertically only one of the receiving unit and the feeding system. In this case, there is an effect that the electric power required to move their unit may be reduced, because the moving part becomes small.

Because this embodiment uses the configuration in which the regenerative electric power is returned to battery 114. Therefore, if the elevator moves up and down, it becomes the regenerative mode in either upper and lower movement. Accordingly, even if the feeding power time is not so long, it is unquestionable on practical use because the electrical discharge from the battery is small.

Further, in the time when the passenger to the same direction increases continuously, for instance, going to work or returning from one's office, etc. in the office building, the elevator-car is always operated in a power mode. For such a case, the capacity of the battery may be set in consideration of the maximum amount of the power consumption, or a plurality of the feeding units may be provided on a plurality of the feeding floors. Thereby, the effective feeding time can be increased. Although the position sensor was separately installed in the above-mentioned embodiment, it is also possible to detect the position by using the characteristic of the transformer itself. Such an example will be explained as follows.

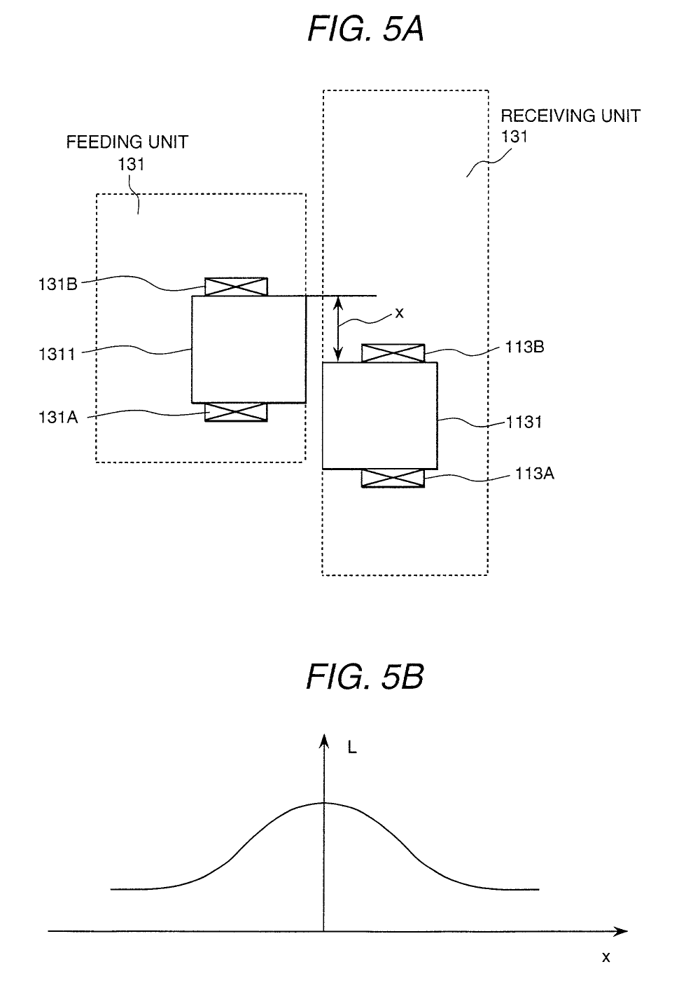

FIG. 5A is a schematic view showing the section of a feeding system 131 and a receiving unit 113 according to another embodiment of the invention. FIG. 5B is a graph showing the characteristic of a transformer according to another embodiment, in which self-inductance L when the voltage with a constant frequency and a constant amplitude is applied to the transformer was plotted with respect to the displacement x.

The self-inductance L decreases, because the main magnetic flux may decrease when the positions of the transformers are misarranged. Therefore, the transformers oppose correctly at the position where self-inductance L becomes the maximum. The position can be detected by using this principle, in practice, by measuring the phase difference between the voltage and the electric current.

It is not required to provide newly the position sensor according to such a method. Therefore, there is an effect that the configuration becomes simple and the cost is reduced.

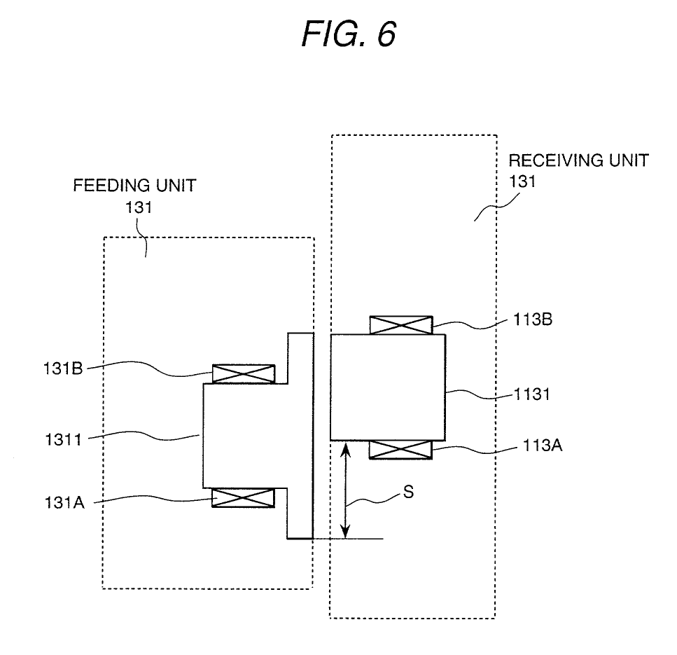

FIG. 6 is a schematic view showing the section of a feeding system 131 and a receiving unit 113 according to another embodiment.

In this embodiment, the gap side core length of feeding transformer 1311 on the feeding unit side is set to be longer. This core length is almost equal to the sum of the maximum rope expansion length L and the gap side core length of receiving transformer 1131 on the receiving unit side. As a result, even when the receiving transformer 1131 falls by the rope expansion, it does not come off from the feeding transformer 1311, and the transfer characteristics according to the design can be obtained. Here, the maximum rope expansion length L means the maximum aging length in the maintenance interval when the length of the rope is adjusted. For example, the length is between 100 mm and 200 mm in an elevator of which the travel length is approximately 60 m.

In this embodiment, some characteristics decrease, because there is a useless core part in the feeding side transformer. However, it exhibits the stable characteristic with respect to the rope expansion. Further, it becomes possible to construct simply the elevator system, because it is not required to carry out the point-to-point control on the counter weight side, differently from the previous embodiment.

In this embodiment, the core of the transformer has the uniform shape in a vertical direction where the elevator is moved as understood from FIG. 6. Therefore, a magnetic characteristic does not change due to the displacement. In other words, when a core of C type or E type form, etc. is used, it is important to arrange the core so that the ditch may become vertical.

As for this, because the influence of the displacement is a little, it is desirable to use the similar arrangement even when the counter weight is positioned.

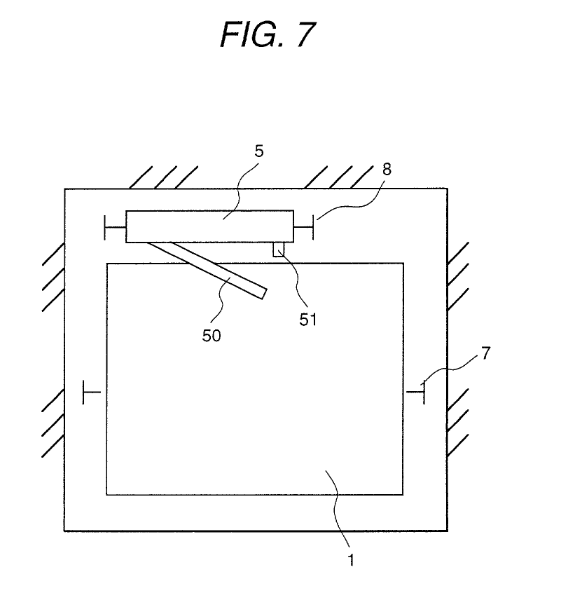

FIG. 7 is a top view of an elevator according to another embodiment.

For instance, to protect internal equipment from dust in the hoistway, the motor control unit 11 installed in counter weight 5 is stored in a housing.

A movable or detachable check door 50 is provided in the case and on the opposite side of the wall of the hoistway. A safety unit 51 is installed on this check door 50 so that the switch may work at an open door, and the operation of the elevator may stop.

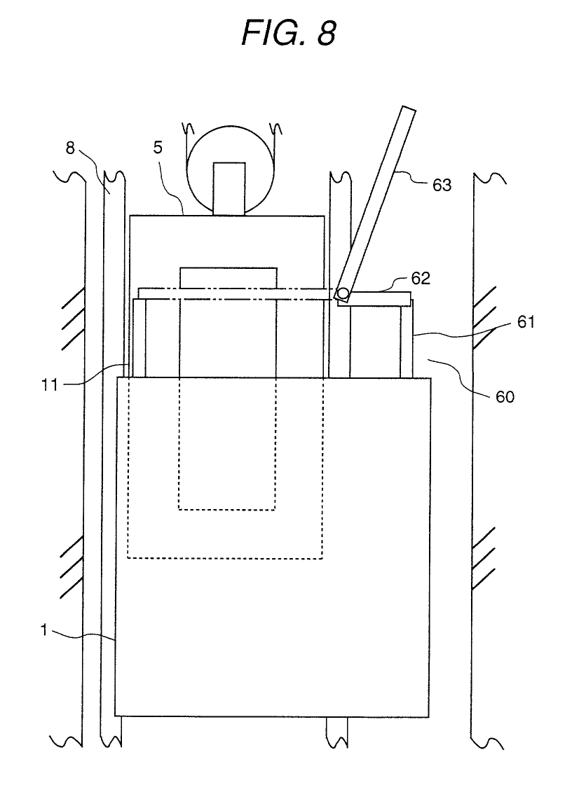

FIG. 8 is a front elevation of the elevator shown in FIG. 7.

A handrail 60 with some height is provided on a plane of the elevator-car in the upper part of elevator-car 1. As for this handrail 60, crossbars 62 and 63 are fixed to a pillar 61. Crossbar 63 on the counter weight side is installed rotatably in an up direction.

The control unit 11 installed in the counter weight is checked as follows. The elevator is made to go up and down after boarding on the ceiling of the elevator-car 1 or pit on the bottom of the hoistway. The elevator-car is stopped so that the counter weight 5 may come to the appropriate position, and then the check is started. In this case, check door 50 installed on the opposite side of the wall of the hoistway is opened and control unit 11 installed in counter weight 5 is checked.

Further, when the worker boards the ceiling of elevator-car 1 and works, the fall prevention of the worker can be achieved with handrail 60 installed on elevator-car 1 while the counter weight is made to be gone up and down to an appropriate position. The crossbar 63 of the handrail 60 on the counter weight side is moved to the position where does not become obstructive.

This check door 50 projects to the elevator-car side. However, the safety unit 51 operates, and thus the elevator does not go up and down while the check door 50 is open.

By using the above-mentioned configuration, it is possible to check safely even if the counter weight includes the control unit etc. to be check.

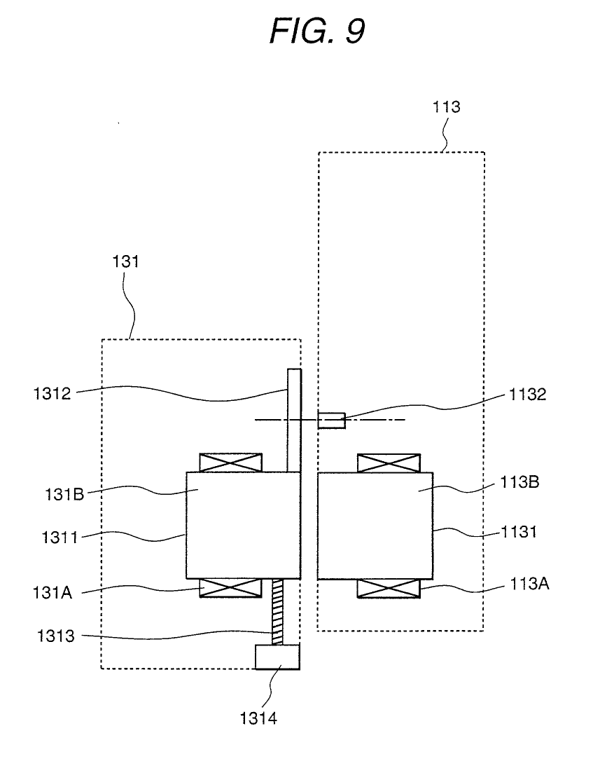

FIG. 9 shows the configuration of the feeding unit and the receiving unit according to another embodiment of the present invention. In the configuration shown in FIG. 9, the mechanism to move the feeding unit itself in up and down directions is added to the configuration shown in FIG. 3. The mechanism comprises a ball screw 1313 for moving the transformer 1311 in up and down directions, and a motor 1314 for rotating the ball screw, in which the motor 1314 is driven according to the displacement detected by a position sensor 1312 to suppress the displacement of the feeding unit.

While the feeding side of the elevator system has been moved in up and down directions in this embodiment, it may be possible to move the receiving side of the elevator system. Further, while the sensor is provided on the receiving side, it may be possible to provide it on the feeding side of the elevator system. These arrangements can be changed according to the configuration of the system.

What is claimed is:

1. An elevator in which an elevator-car and a counter weight are hung like a draw well, comprising:
a receiving means for receiving an electric power from a feeding means provided in a hoistway,
an inverter for converting the received electric power into ac power,
a motor connected to an ac side of said inverter, for driving said counter weight in up and down directions,
a means for detecting a position of said receiving means; and
a means for controlling an inverter on the basis of the position detected by said position detecting means;
wherein said counter weight has said receiving means, said inverter, and said motor.

2. An elevator in which an elevator-car and a counter weight are hung like a draw well, comprising:
a receiving means for receiving an electric power from a feeding means provided in a hoistway,
an inverter for converting the received electric power into ac power,
a motor connected to an ac side of said inverter, for driving said counter weight in up and down directions,
a means for detecting a position of said receiving means, and
a means for controlling an inverter so that said receiving means may be arranged at a position where an electric power can be supplied from said feeding means, on the basis of the position detected by said position detecting means,
wherein said counter weight has said receiving means, said inverter, and said motor.

3. An elevator in which an elevator-car and a counter weight are hung like a draw well, comprising:
a receiving means for receiving an electric power from a feeding means provided in a hoistway,
an inverter for converting the received electric power into ac power,
a motor connected to an ac side of said inverter, for driving said counter weight in up and down directions,
a means for detecting a position of said receiving means; and
a means for controlling an inverter so that said feeding means may be moved at a position where an electric power can be supplied to said receiving means, on the basis of the position detected by said position detecting means;
wherein said counter weight has said receiving means, said inverter, and said motor.

4. An elevator in which an elevator-car and a counter weight are hung like a draw well, comprising:
a receiving means for receiving an electric power from a feeding means provided in a hoistway,
an inverter for converting the received electric power into ac power,
a motor connected to an ac side of said inverter, for driving said counter weight in up and down directions,
a means for detecting positions of the feeding means and the receiving means; and
a means for controlling said inverter on the basis of the positions detected by said position detecting means;
wherein said counter weight has said receiving means, said inverter, and said motor.

5. An elevator in which an elevator-car and a counter weight are hung like a draw well, comprising:
a receiving means for receiving an electric power from a feeding means provided in a hoistway,
an inverter for converting the received electric power into ac power,
a motor connected to an ac side of said inverter, for driving said counter weight in up and down directions,
a means for detecting a position of said receiving means; and
a means for controlling an inverter so that the displacement between the position of said feeding means and one of said receiving position is reduced, on the basis of the position detected by said position detecting means;
wherein said counter weight has said receiving means, said inverter, and said motor.

6. An elevator in which an elevator-car and a counter weight are hung like a draw well, comprising:
an inverter for converting the received electric power into ac power,
a motor connected to an ac side of said inverter, for driving said counter weight in up and down directions, and
a control panel for controlling an inverter,
wherein said counter weight has said inverter, said motor, and said control panel, and
wherein said control panel has a check door on the opposite side of the wall of the hoistway.

7. An elevator according to claim 6, further comprising a means for stopping said counter weight in response to the open operation of said check door.

8. An elevator in which an elevator-car and a counter weight are hung like a draw well, comprising:
a receiving unit for receiving an electric power from a feeding unit provided in a hoistway,
an inverter for converting the received electric power into ac power,
a motor connected to an ac side of said inverter, for driving said counter weight in up and down directions, and
a detector for detecting a position of the receiving unit,
wherein said inverter is controlled so that said receiving unit may be arranged at a position where an electric power can be supplied from said feeding unit, on the basis of the position detected by said position detector,
wherein said counter weight has said receiving unit, said inverter, and said motor.

9. An elevator in which an elevator-car and a counter weight are hung like a draw well, comprising:
a receiving unit for receiving an electric power from a feeding unit provided in a hoistway,
an inverter for converting the received electric power into ac power,
a motor connected to an ac side of said inverter, for driving said counter weight in up and down directions, and
a detector for detecting a position of the receiving unit,
wherein said inverter is controlled so that said feeding unit may be moved at a position where an electric power can be supplied to said receiving unit, on the basis of the position detected by said position detector, and
wherein said counter weight has said receiving unit, said inverter, and said motor.
